(19) United States
(12) Patent Application Publication
(10) Pub. No.: US 2013/0236141 A1
(43) Pub. Date: Sep. 12, 2013

(54) OPTICAL CABLE CONNECTION CLOSURE

(71) Applicant: 3M INNOVATIVE PROPERTIES COMPANY, ST. PAUL, MN (US)

(72) Inventor: Takaya YAMAUCHI, Sagamihara (JP)

(73) Assignee: 3M INNOVATIVE PROPERTIES COMPANY, ST. PAUL, MN (US)

(21) Appl. No.: 13/779,831

(22) Filed: Feb. 28, 2013

(30) Foreign Application Priority Data
Mar. 9, 2012 (JP) 2012-053080

(51) Int. Cl. G02B 6/44

(52) U.S. Cl. CPC G02B 6/444
USPC 385/75

(57) ABSTRACT

An optical cable connection closure allowing for improved esthetic appeal is disclosed. An optical cable connection closure is housed within trunk optical cables. The optical cable connection closure is suspended from a messenger wire, and is provided with a closure body that is rigid enough to support trunk optical cables, branching optical cables, and optical connectors. The closure body has a first layer for housing the trunk optical cables, a second layer for housing the second optical cables, and a third layer for housing the optical connectors. The first through the third layers are layered in that order in the suspension direction and the perpendicular direction, and at least a part thereof overlaps as seen from the perpendicular direction.

### RELATED APPLICATIONS

This application claims priority from Japanese Application No. 2012-053080, filed Mar. 9, 2012, the disclosure of which is incorporated by reference herein in its entirety.

### BACKGROUND

1. Technical Field

The present invention relates to an optical cable connection closure.

2. Related Art

Conventionally, in the construction of a fiber-to-the-home (FTTH) network, an optical cable may be split off from a cable in an overhead line system and the optical cable is then drawn into a residence and the like. An optical cable connection closure is widely used as the location at which the optical cable is split off from the overhead line system cable. A known example of such art, as disclosed, for example, in patent document 1, is an optical fiber distribution box allowing for an optical fiber (branching optical cable) to be split off from an overhead optical drop cable (trunk optical cable) and drawn into a residence and the like.

The optical fiber distribution box disclosed in Japanese Unexamined Patent Application Publication No. 2006-53261 (Patent Document 1) is provided with a housing (closure body) having a housing space for housing optical fibers and the like and a plate-shaped piece for suspending the housing from a support line of the optical drop cable. The housing is provided with an optical fiber housing space arranged in the center of the housing, and a retaining piece for retaining an optical connection arranged so as to sandwich the optical fiber housing space along the direction of suspension.

### SUMMARY

The optical cable, messenger wire, and the like of a cable group of an overhead line system are generally bundled together by a spiral-shaped spiral hanger. Thus, an optical cable connection closure (hereafter, also referred to as simply “closure”) is normally suspended from the messenger wire, and installed near the residence into which the optical cable is to be drawn. When an optical cable connection closure is installed near a residence in this way, it is desirable to reduce the size of the closure and make it less conspicuous, thereby ensuring the esthetic appeal of the closure.

However, in the conventional optical fiber distribution box described above, the dimensions, for example, of the suspension direction may be large, making the housing suspended from the messenger wire conspicuous. Therefore, there is the risk of the esthetic appeal of the optical cable connection closure being reduced. Thus, there has been a demand in recent years for an optical cable connection closure that can be made less conspicuous when suspended from a messenger wire, allowing for improved esthetic appeal.

The present invention was contrived in light of the circumstances described above, and an object of the present invention is to provide an optical cable connection closure that can improve the esthetic appeal.

The present invention is an optical cable connection closure having at least first and second mutually separable optical cables, the closure housing a trunk optical cable extending in a predetermined direction and optically connecting a branching optical cable to the second optical cable via an optical connector. The optical cable connection closure is suspended from a wire for supporting the trunk optical cable, and is provided with a rigid closure body capable of supporting the trunk optical cable, branching optical cable, and optical connector. The closure body has a first layer for housing the trunk optical cable, a second layer for housing the separated second optical cable, and a third layer for housing the optical connector, the first through the third layers being layered in that order in a direction perpendicular to the direction in which the closure body is suspended and the predetermined direction, and at least a part thereof overlapping as seen from the perpendicular direction.

In the optical cable connection closure, the first layer that houses the trunk optical cable, the second layer that houses the second optical cable, and the third layer that houses the optical connector are layered in the perpendicular direction. The first through the third layers are arranged so that at least parts thereof overlap one another as seen from the perpendicular direction. Such a configuration allows the dimensions of the closure body in the suspension direction to be reduced, and the closure body to be made more compact. It is thereby possible to make the closure body suspended from the wire inconspicuous, and to improve the esthetic appeal of the optical cable connection closure suspended from the wire.

The closure body also preferably has a fourth layer for housing the branching optical cable, this fourth layer being included within either the second or the third layer. This allows for favorable housing of the branching optical cable and for the closure body to be made more compact.

A specific example of a configuration favorably yielding the effects described above is one in which the closure body is formed in a box shape with a first shell and a second shell abutting each other in the perpendicular direction, the first layer being provided within the first shell, and the third layer being provided within the second shell.

Another specific example of a configuration favorably yielding the effects described above is one in which the closure body is formed with a frame extending in a predetermined direction so as to delineate first and second housing sections, the first layer being provided within the first housing section, and the third layer being provided within the second housing section.

A plurality of catches for retaining the second optical cable in a state wrapped in the circumferential direction around the axis of the perpendicular direction is preferably provided within the second layer, a part of the plurality of catches catching the second optical cable so as to be movable with respect to the circumferential direction. This allows the second optical cable to be efficiently housed within the second layer regardless of the length of the separated second optical cable.

In accordance with the present invention, it is possible to provide an optical cable connection closure that enables improved esthetic appeal.

### BRIEF DESCRIPTION OF THE DRAWINGS

FIG. 1 is a perspective view of the configuration of an overhead line system from which an optical cable connection closure according to a first embodiment is suspended.

FIG. 2 is a cross-sectional schematic view of the structure of a trunk optical cable.

FIG. 3 is a frontal view of a cover of the optical cable connection closure according to the first embodiment in an open state.

FIG. 4 is a right side view of the optical cable connection closure according to the first embodiment.

FIG. 5 is a perspective view of a case and a cover.

FIG. 6 is a magnified perspective view of part of the case and the cover.

FIG. 7 is a perspective view of a hanger.

FIG. 8 is a left side view of a first manner of attaching the hanger.

FIG. 9 is a left side view of a second manner of attaching the hanger.

FIG. 10 is an illustration that describes an operation of splitting an optical cable using the optical cable connection closure according to the first embodiment.

FIG. 11 is an illustration that describes a step of splitting a second optical cable of a single trunk optical cable.

FIG. 12 is an illustration that describes a step of connecting the second optical cable and a branching optical cable using an optical connector.

FIG. 13 is an illustration that describes a step of housing the second optical cable, the optical connector, and the branching optical cable within a closure body.

FIG. 14 is an illustration of another trunk optical cable in a split state.

FIG. 15 is a perspective illustration that describes an optical cable connection closure according to a second embodiment.

FIG. 16 is another perspective illustration that describes the optical cable connection closure according to the second embodiment.

### DETAILED DESCRIPTION

An embodiment of an optical cable connection closure according to the present invention will be described in detail below with reference to the accompanying drawings. In the following descriptions, identical or similar parts are assigned the same reference number, and any redundant description thereof will be omitted. The terms “inner” and “outer” correspond to the inner and outer sides of the optical cable connection closure. The X, Y, and Z directions are based on the state shown in the drawings, and are for convenience.

### First Embodiment

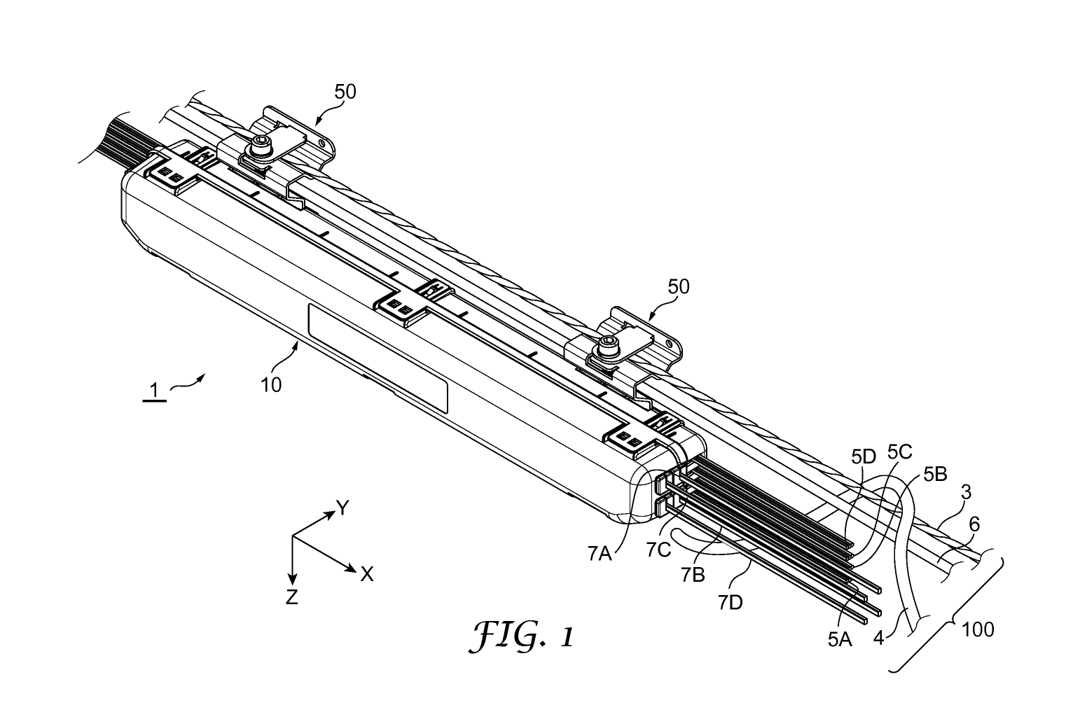

The optical cable connection closure according to the present embodiment is used, for example, at a location at which an optical cable is split off from a cable of an overhead line system forming part of an FTTH network. First, the overhead line system will be described. As shown in FIG. 1, an overhead line system 100 extending in a predetermined direction (X direction) is provided with a cable group, a messenger wire 3, and a spiral hanger 4. The cable group includes, for example, trunk optical cables 5A to 5D and another optical fiber cable 6. The messenger wire 3 works with the spiral hanger 4 to retain the cable group. The spiral hanger 4 extends in a spiral along the X direction, and bundles together the cable group and the messenger wire 3.

A description of the trunk optical cables 5A to 5D follows. In the present embodiment, the four trunk optical cables 5A to 5D extend along the messenger wire 3. The trunk optical cables 5A to 5D all share the same configuration. Thus, the following description will feature trunk optical cable 5A by way of example.

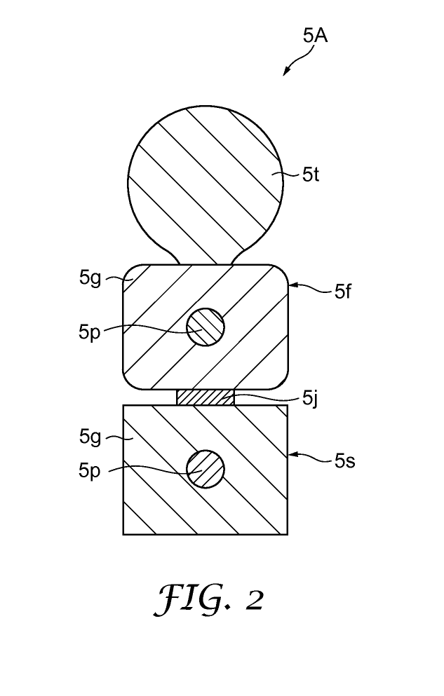

As shown in FIG. 2, the trunk optical cable 5A is provided with a tension wire 5t, a first optical cable 5f, and a second optical cable 5s. The tension wire 5t, first optical cable 5f, and second optical cable 5s are coupled together in that order.

The tension wire 5t, which has a circular cross section, is a metal member for receiving tension acting upon the first and second optical cables 5f and 5s. The first optical cable 5f has an optical fiber 5p having a circular cross section, and an outer sheath 5g having a rectangular cross section covering the optical fiber 5p. The optical fiber 5p is arranged in a position roughly in the center of the cross section of the outer sheath 5g. While not shown in the drawings, the optical cable 5f may also be provided with one or more FRP or metal reinforcing members parallel to the optical fiber 5p. The second optical cable 5s provided alongside the first optical cable 5f has a configuration similar to that of the first optical cable 5f.

The first optical cable 5f and the second optical cable 5s are connected by a coupler 5j in a manner that allows them to be separated, and the first optical cable 5f and second optical cable 5s can be cut apart, as necessary, starting at the coupler 5j.

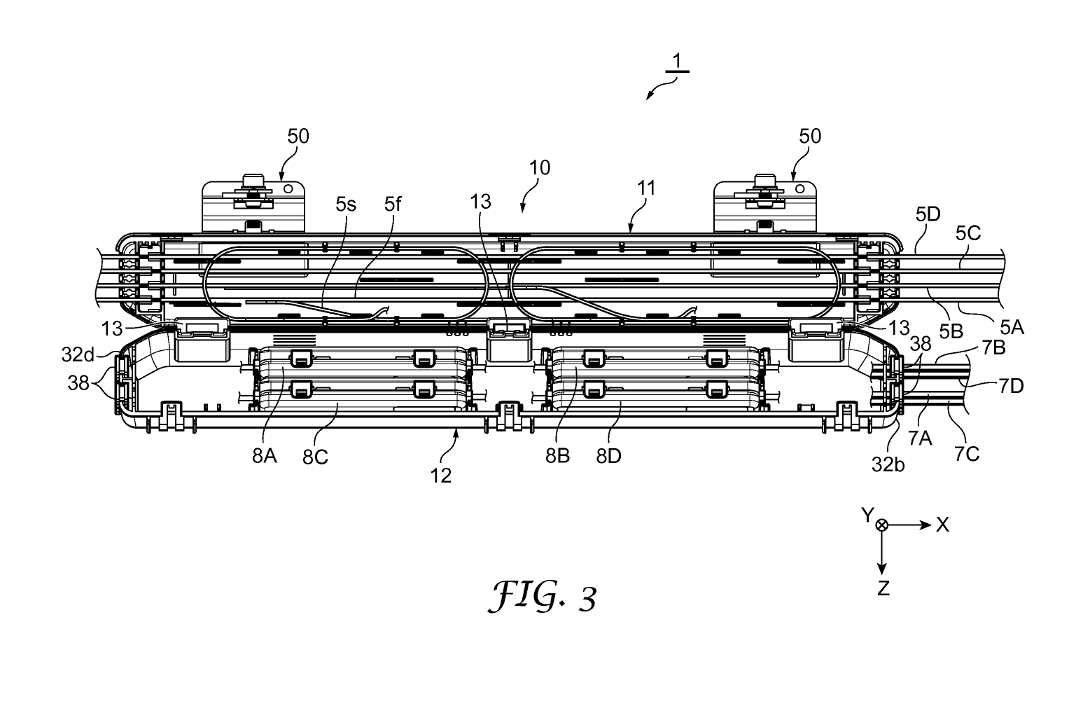

Next, an optical cable connection closure 1 will be described. As shown in FIG. 3, the optical cable connection closure 1 houses at least part of the trunk optical cables 5A to 5D, and optically connects via optical connectors 8A to 8D the branching optical cables 7A to 7D to the single-core second optical cable 5s split off therefrom.

The branching optical cables 7A to 7D are connected to the second optical cable (excess cable length) 5s, and are used to extend into a residence. The optical connectors 8A to 8D have long rectangular shapes. The optical connectors 8A to 8D optically connect the respective second optical cables 5s of the trunk optical cables 5A to 5D and the branching optical cables 7A to 7D so that the two abut each other in the lengthwise direction thereof.

The optical cable connection closure 1 is provided with a closure body 10 for housing the trunk optical cables 5A to 5D and a hanger 50 for suspending the closure body 10 from the messenger wire 3. The closure body 10 of the optical cable connection closure 1 is perpendicularly suspended facing downward in a suspension direction (Z direction) from the messenger wire 3 via the hanger 50.

As shown in FIGS. 3 to 6, the closure body 10 is rigid enough to be capable of supporting the trunk optical cables 5A to 5D, the branching optical cables 7A to 7D, and the optical connectors 8A to 8D, and forms, for example, the skeleton of the optical cable connection closure 1. The closure body 10 in the present discussion is made of plastic. The rigidity of the closure body 10 can be set using, for example, the strength of the plastic forming the closure body 10, the shape (dimensions) thereof, and the like.

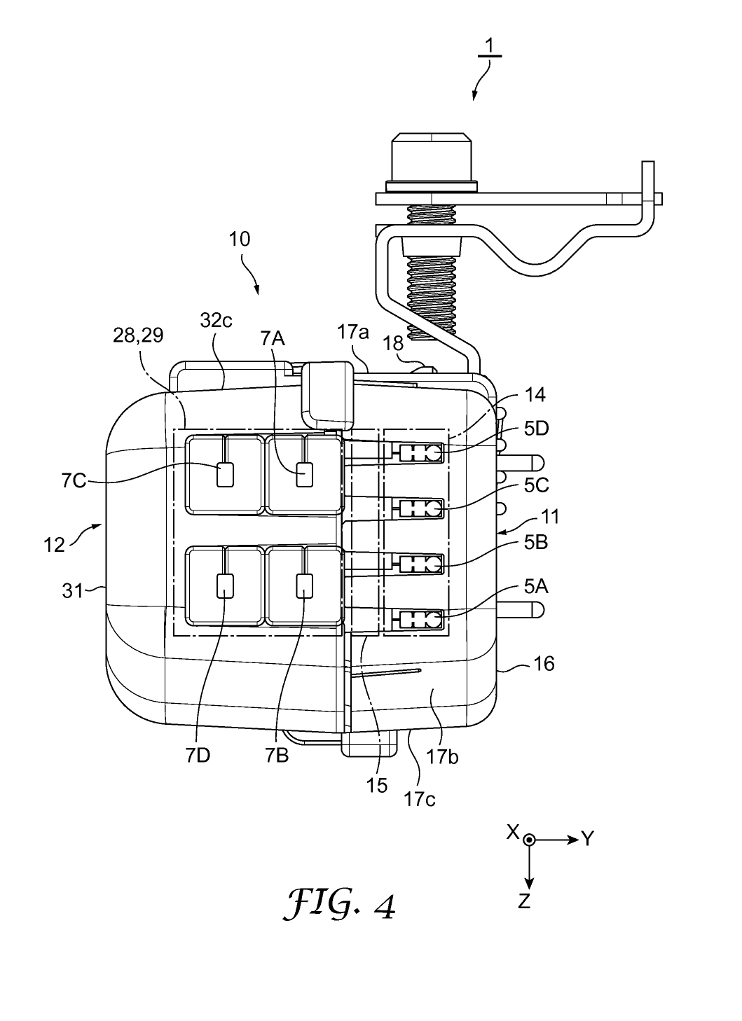

The closure body 10 has a base 11 constituting a first shell, and a cover 12 constituting a second shell. The base 11 and the cover 12 are coupled by a hinge 13 so as to be rotatable with respect to each other around an axis of rotation following the X direction. The cover 12 is thereby opened and closed with respect to the base 11. When the base 11 and the cover 12 are in a state of closure (“closed state”) in which the two abut each other in the perpendicular direction (Y direction) perpendicular to the X direction and the Z direction, the closure body 10 forms a box shape that is long with respect to the X direction (see FIG. 4)

The base 11 houses the trunk optical cables 5A to 5D and the second optical cable 5s separated from the first optical cable 5f. The base 11 has a first layer 14 for housing the trunk optical cables 5A to 5D and a second layer 15 for housing the second optical cable 5s (see FIG. 4). The first and second layers 14 and 15 each extend in the X direction.

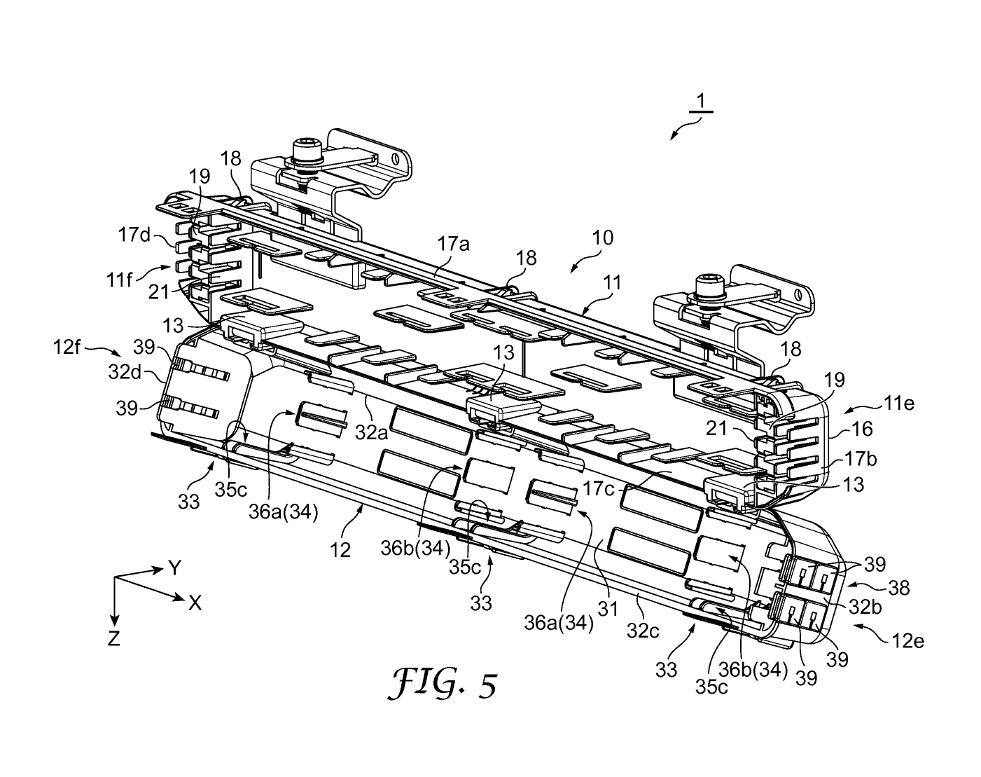

As shown in FIG. 5, the shell-shaped base 11 consists of a plate-shaped base floor portion 16 and side walls 17a to 17d rising from the periphery of the base floor portion 16. Hinges 13 are provided at positions near both ends and roughly in the center of the side wall 17c, which is perpendicular to the Z direction. A projection 18 for engaging with the cover 12 when the base 11 and the cover 12 are in the closed state and for fixing the cover 12 to the base 11 is provided on the side wall 17a, which is on the side opposite to the side wall 17c.

The first layer 14 (see FIG. 4) is an area established at the base floor portion 16 within the base 11 and has the X direction as its lengthwise direction. The first layer 14 consists of a pair of rubber seals 19 located near both ends of the base 11. The rubber seals 19 are provided with four grooves extending in the X direction, the grooves retaining the trunk optical cables 5A to 5D. Each of the pair of rubber seals 19 are arranged at positions located at a predetermined distance inward away from the side walls 17b and 17d, which are perpendicular to the X direction.

As described above, the first layer 14 contains the rubber seals 19 provided on the base 11. In other words, the closure body 10 of the present embodiment need not be a separate piece from the base 11, and the base 11 itself serves to house the trunk optical cables 5A to 5D.

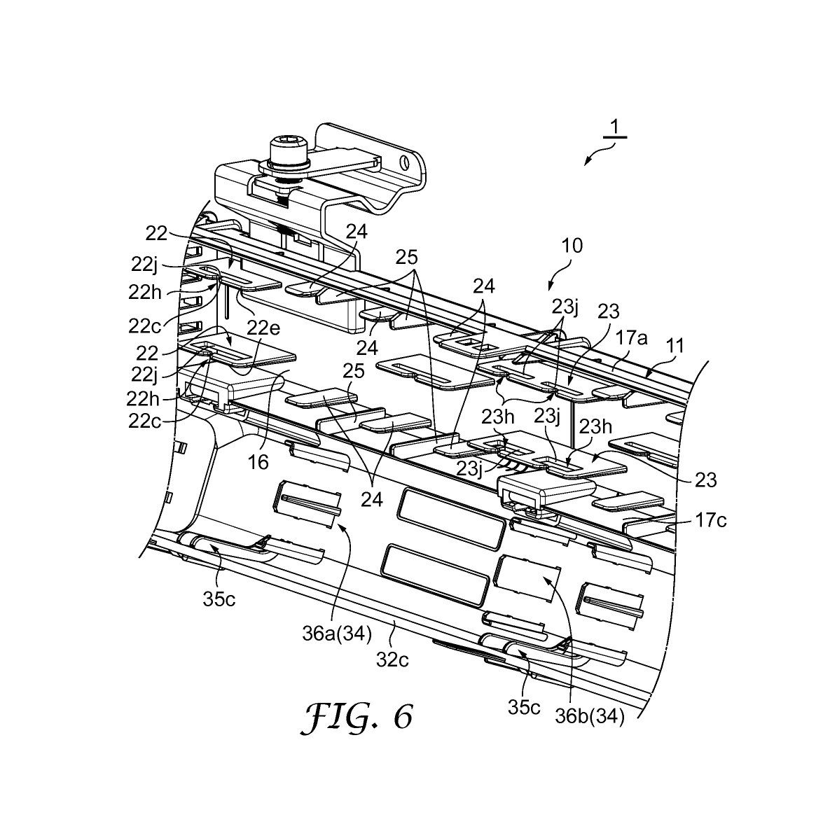

The second layer 15 (see FIG. 4) is an area established at the inside of the first layer 14 with respect to the Y direction (the side opposite the base floor portion 16) in the base 11, and has the X direction as its lengthwise direction. In other words, the first layer 14 and the second layer 15 are layered in the Y direction so as to be in the same position in the Z direction. As shown in FIG. 6, the second layer 15 contains first catches 22 and 23 and second catches 24 and 25 constituting a plurality of catches. The catches 22 to 25 retain the second optical cable 5s in a state wrapped along the circumferential direction around an axis extending in the Y direction.

As shown in FIG. 6, the first catches 22 are vertical pieces rising from the base floor portion 16, and have a rectangular plate shape having a surface perpendicular to the Z direction. Hooks 22h are provided on the inner ends (apical ends) of the first catches 22. The hooks 22h delineate a space 22j for retaining the second optical cable 5s. At the hooks 22h, the second optical cable 5s is guided into the space 22j through a gap 22c externally linking the space 22j. The hooks 22h are formed so as to be positioned further to the inside with respect to the Y direction than the trunk optical cables 5A to 5D retained by the rubber seals 19. A first catch 22 is arranged in each of the four corners of the second layer 15.

The first catches 23 are vertical pieces rising from the base floor portion 16, and have a rectangular plate shape having a surface perpendicular to the Z direction. Two hooks 23h are provided along the X direction on the inner ends of the first catches 23. The hooks 23h are configured similarly to the hooks 22h of the first catch 22 described above. Two first catches 23 are provided on the base 11. Specifically, the first catches 23 are located at positions roughly in the center of the base 11 with respect to the X direction near the side wall 17a and near the side wall 17c.

The second catches 24 are vertical pieces rising from the base floor portion 16 and have a rectangular plate shape having a surface perpendicular to the Z direction. The second catches 24 are located at positions near the side wall 17a and the side wall 17c and between the first catches 22 and 23. The second catches 25 are vertical pieces rising from the base floor portion 16 and have a rectangular plate shape having a surface perpendicular to the X direction. The second catches 25 are located between the plurality of second catches 24 with respect to the X direction.

The second catches 24 and 25 are preferably arranged so as to overlap as seen from the X direction. This allows the second optical cable 5s to be easily threaded between the second catches 24 and 25 when the second optical cable 5s is wrapped around the catches 22 to 25, and for the second optical cable 5s to be retained while ensuring a constant radius that is equal to or greater than an acceptable bend radius. The second catches 24 and 25 are capable of reliable retention without placing stress upon the second optical cable 5s.

As discussed above, the second layer 15 contains the first catches 22 and 23 and the second catches 24 and 25 provided on the base 11. In other words, the closure body 10 need not be a separate piece from the base 11, and the base 11 itself serves to house the second optical cable 5s.

As shown in FIG. 3, the cover 12 houses the optical connectors 8A to 8D and the branching optical cables 7A to 7D. Specifically, as shown in FIG. 4, the cover 12 has a third layer 28 for housing the optical connectors 8A to 8D and a fourth layer 29 for housing the branching optical cables 7A to 7D.

As shown in FIG. 5, the shell-shaped cover 12 contains a plate-shaped cover floor portion 31 and side walls 32a to 32d that rise from the periphery of the cover floor portion 31. A hinge 13 is provided on the side wall 32a, which is perpendicular to the Z direction when the base 11 and the cover 12 are in an opened state (“open state”). A locking part 33 is provided on the side wall 32c opposite the side wall 32a at a position corresponding to that of the projection 18 of the base 11. The locking part 33 engages with the projection 18 of the base 11 in the closed state, securing the cover 12 to the base 11. This configuration of the cover 12 allows a sealed space for housing the first through fourth layers 14, 15, 28, and 29 to be delineated in a manner that allows opening and closing.

The third layer 28 (see FIG. 4) is an area established within the cover 12. The third layer 28 contains clamps 34 established along the X direction. Each of the clamps 34 has vertical pieces 36a and 36b rising from the cover floor portion 31. The interval between the vertical pieces 36a and 36b in the X direction is roughly the same length as the length of the optical connectors 8A to 8D in the lengthwise direction. This enables the optical connectors 8A to 8D to be clamped between the vertical pieces 36a and 36b, and as a result, the optical connectors 8A to 8D can be attached to the cover 12.

As discussed above, the third layer 28 contains the clamps 34 provided on the cover 12. In other words, the closure body 10 need not be a separate piece from the cover 12, and the cover 12 itself serves to house the optical connectors 8A to 8D. In the closed state, the third layer 28 is set so as to overlap the first and second layers 14 and 15 as seen from the Y direction, and the first through the third layers 14, 15, and 28 are each layered in the Y direction.

The fourth layer 29 (see FIG. 4) is an area included in the third layer 28. The fourth layer 29 is constituted by the area outside the area in which the optical connectors 8A to 8D are positioned within the cover 12. In other words, the closure body 10 need not be a separate piece from the cover 12, and the cover 12 itself serves to house the branching optical cables 7A to 7D.

A retaining piece 38 for retaining the branching optical cables 7A to 7D and guiding them outside the closure body 10 is provided on the side walls 32b and 32d of the cover 12 (see FIG. 3). The retaining piece 38 is provided with four rubber seals 39 located on the side wall 32b towards an end 12e of the cover 12, and with four rubber seals 39 located on the side wall 32d toward another end 12f of the cover 12. This configuration yields a cover 12 in which eight outlets for leading the branching optical cables 7A to 7D to the outside of the closure body 10 are provided.

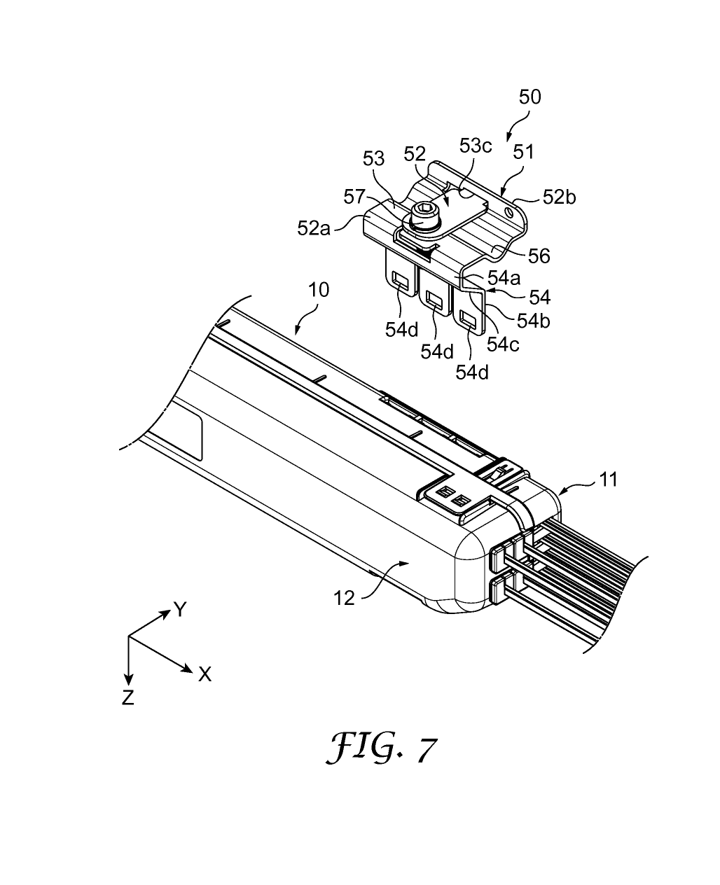

Next, the hanger 50 will be described. As shown in FIG. 7, the hanger 50 is for suspending the closure body 10 from the messenger wire 3. The hanger 50 is provided with a base plate 51 and a grip plate 52. The base plate 51 has a base 53 extending in the Y direction, and an anchor 54 extending downwards (on one side in the Z direction) from an end 52a of the base 53. The base plate 51 is integrally formed from a single bent plate.

The base 53 is provided with a groove 56 that opens upward (on the other side in the Z direction) and extends in the X direction in order to locate the messenger wire 3. An end 52b of the base 53 on the side opposite the end 52a is formed as it is bent upward with respect to the base 53 so as to extend in the Z direction. A through-hole 53c into which the grip plate 52 is inserted is provided in the end 52b. The through-hole 53c is a rectangular hole penetrating in the Y direction.

The anchor 54 has a first part 54a extending in the Z direction, a second part 54b located nearer the other end 52b of the base 53 than the first part 54a and extending in the Z direction, and a third part 54c that connects the first part 54a and second part 54b. The second part 54b is positioned between the end 52a and the groove 56 as seen from the Z direction. In other words, as shown in the drawing, the second part 54b is located not directly underneath the messenger wire 3, but rather in a position offset from the messenger wire 3 in the Y direction. An anchor 54d for securing the hanger 50 to the base 11 is provided on the second part 54b. The anchor 54d engages with a claw (not shown) provided on the base 11, coupling the hanger 50 to the base 11.

The grip plate 52 is a plate-shaped member that extends in the Y direction. One end of the grip plate 52 is inserted into the through-hole 53c provided in the base plate 51, and the other end is secured to the base 53 by a bolt 57. The grip plate 52 is arranged so as to close off part of the groove 56, thereby working with the base 53 to grip the messenger wire 3 located in the groove 56.

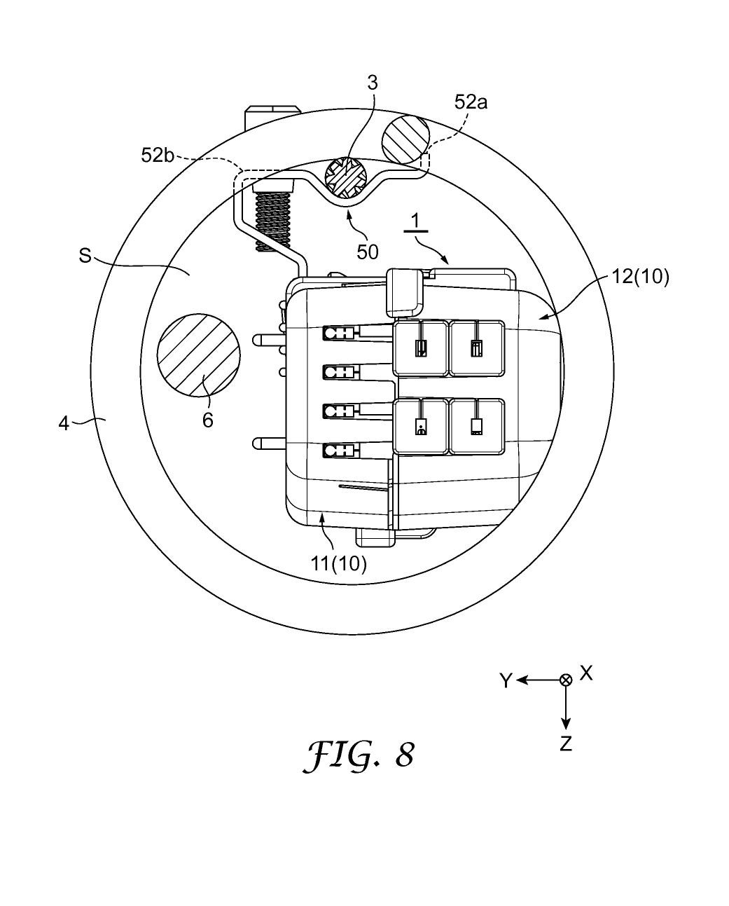

The hanger 50 can be secured to the base 11 by changing the orientation of the hanger 50 (that is, the positional relationship of the ends 52a and 52b of the base plate 51). For example, as shown in FIG. 8, the hanger 50 can be secured to the base 11 so that the end 52a is positioned towards the cover 12 (that is, so that the end 52b is positioned towards the base 11). Such a configuration reduces the distance between the closure body 10 and the messenger wire 3 in the Y direction. This causes the closure body 10 to be situated within the spiral constituted by the spiral hanger 4. It is thereby possible to make the optical cable connection closure 1 inconspicuous, and to improve the esthetic appeal of the optical cable connection closure 1.

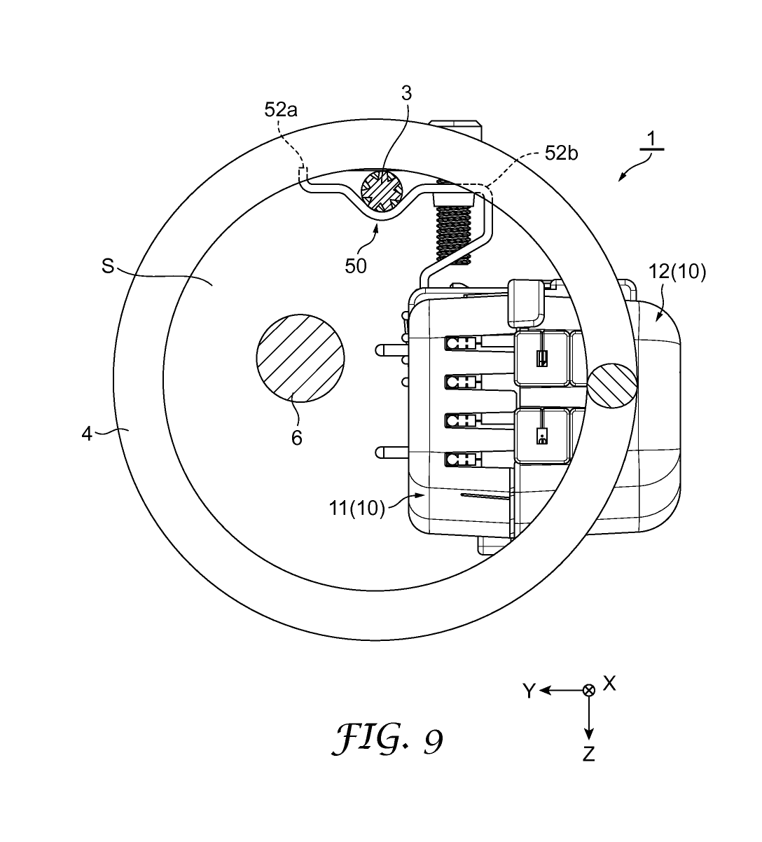

On the other hand, as shown in FIG. 9, the hanger 50 can be secured to the base 11 so that the end 52a is positioned towards the base 11 (that is, so that the end 52b is positioned towards the cover 12). Such a configuration increases the distance between the closure body 10 and the messenger wire 3 in the Y direction. As opposed to the configuration shown in FIG. 8, this enables a space S formed between the closure body 10 and the spiral hanger 4 to be expanded, thereby allowing many cables to be inserted into (housed within) the space S.

Next, a method of connecting the branching optical cables 7A to 7D to the second optical cables 5s of the trunk optical cables 5A to 5D using the optical cable connection closure 1 will be described.

Step 1

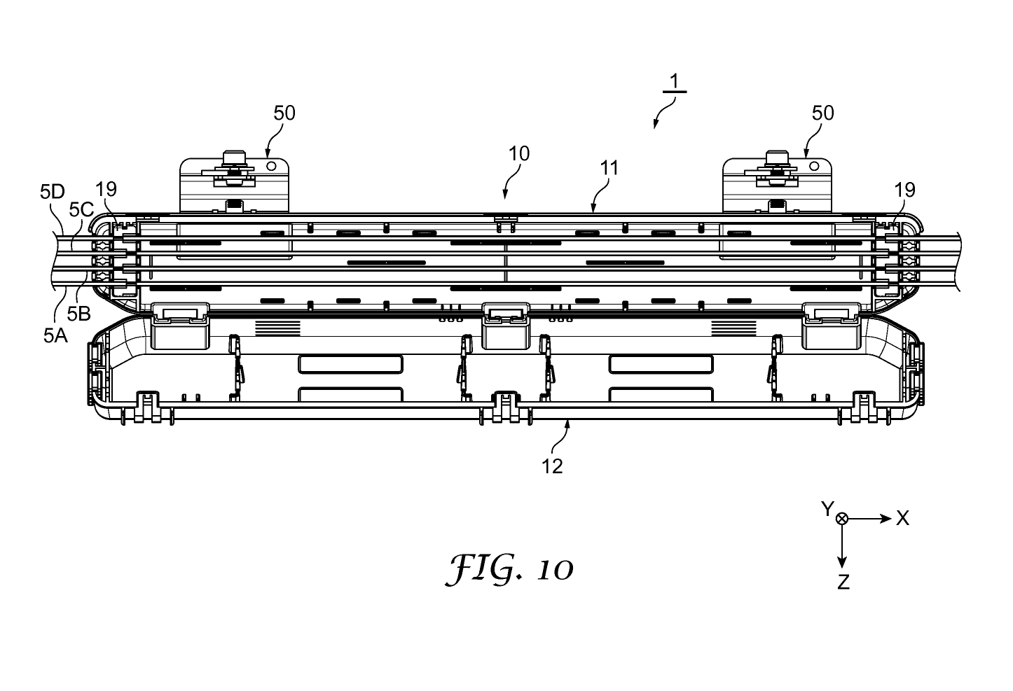

First, as shown in FIG. 10, the trunk optical cables 5A to 5D are housed within the first layer 14 (see FIG. 4) with the cover 12 of the closure body 10 in an open state. Specifically, the trunk optical cables 5A to 5D are arranged within the base 11 so as to extend along the X direction, and are inserted into the grooves in the rubber seals 19 so as to form roughly equidistant rows in the Z direction.

Step 2

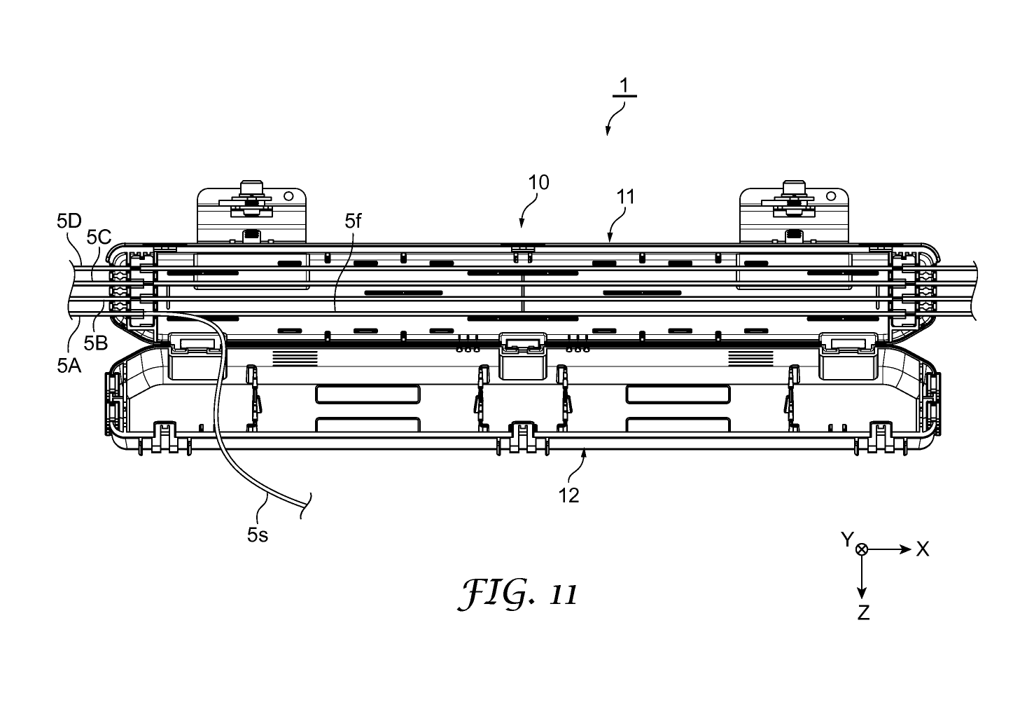

Next, as shown in FIG. 11, only the second optical cable 5s included in the trunk optical cable 5A is cut, and the second optical cable 5s is separated from the first optical cable 5f along the coupler 5j (see FIG. 2).

Step 3

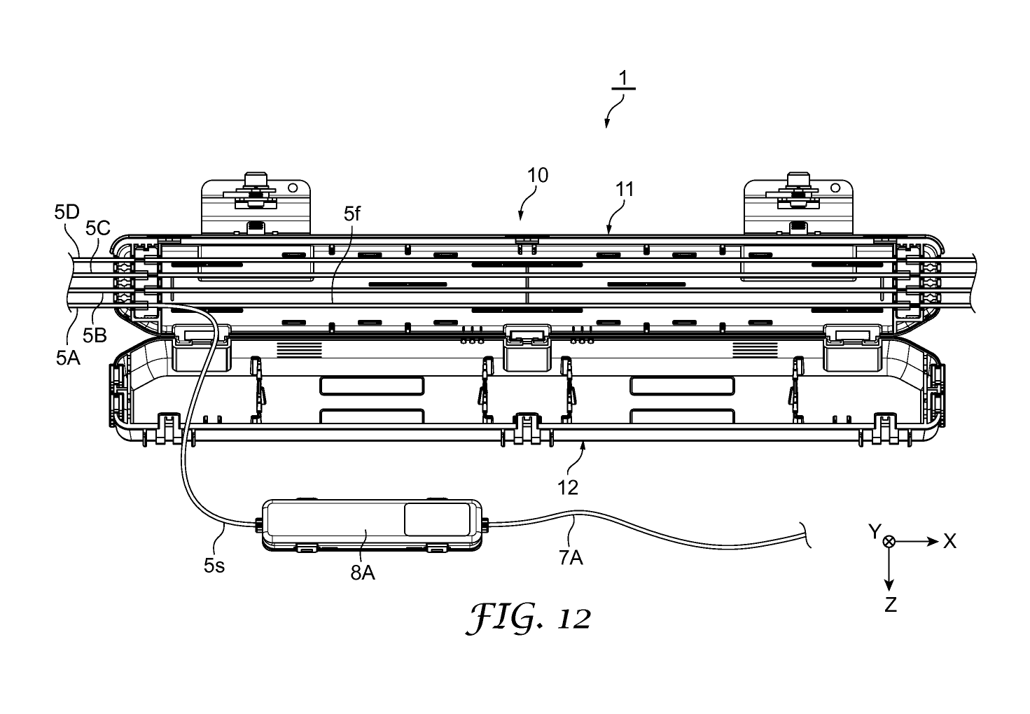

Next, as shown in FIG. 12, the second optical cable 5s and the branching optical cable 7A are optically connected using the optical connector 8A. A known optical connector can be used as the optical connector 8A.

Step 4

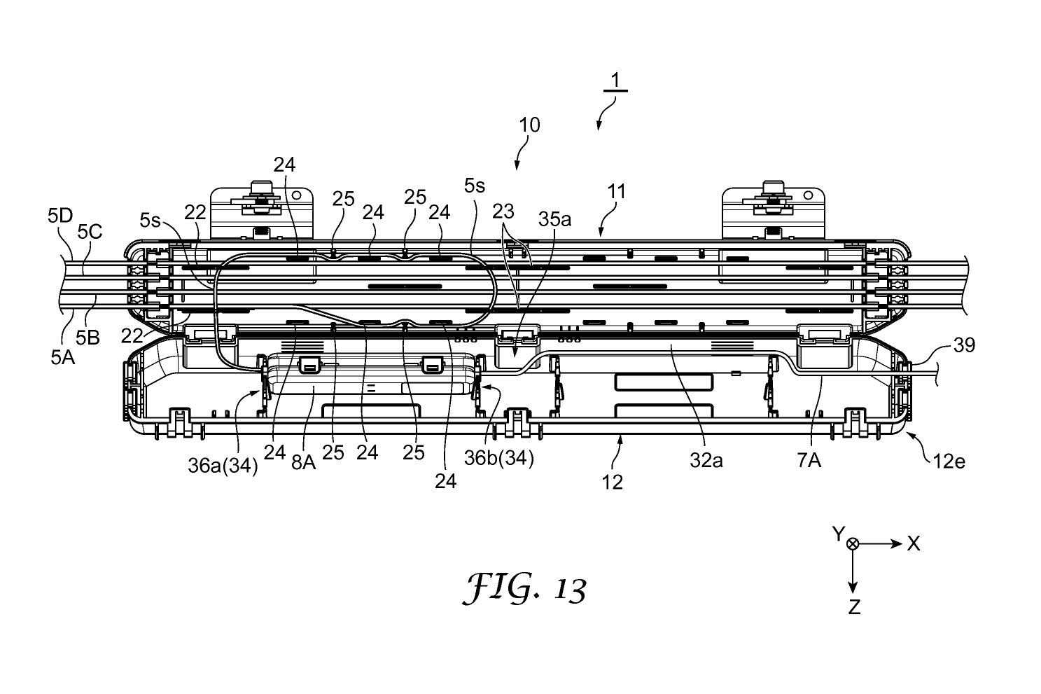

Next, as shown in FIG. 13, the second optical cable 5s is housed in the second layer 15 (see FIG. 4), and the second optical cable 5s is retained in a wrapped-around state. In other words, the second optical cable 5s is hung on the first through fourth catches 22 to 25 as the second optical cable 5s is being wrapped around in the circumferential direction around an axis in the Y direction.

At this time, the second optical cable 5s is inserted through the gap 22c into the spaces 22j and 23j of the first catches 22 and 23 (see FIG. 6), and the second optical cable 5s is inserted so as to be threaded between the second catches 24 and 25. The second optical cable 5s is thereby held in place so as to be movable in the circumferential direction around an axis in the Y direction.

As described above, the first catches 22 and 23 and second catches 24 and 25 for retaining the second optical cable 5s wrapped in the circumferential direction around the Y direction are provided within the second layer 15. These catches 22 to 25 allow the second optical cable 5s to be held in place so as to be movable in the circumferential direction. It is thereby possible to house the second optical cable 5s within the second layer 15 regardless of the length of the second optical cable 5s. In this case, the need to precisely set the length of the second optical cables 5s separated from the trunk optical cables 5A to 5D can be reduced, and the second optical cables 5s can be retained without removing the optical connectors 8A to 8D and without applying stress thereto even if the lengths of the second optical cables 5s vary. As a result, the ease of housing the trunk optical cables 5A to 5D within the optical cable connection closure 1 can be further improved.

Next, the optical connector 8A is retained by the clamps 34 of the cover 12, and as a result, the optical connector 8A is housed in the third layer 28 (see FIG. 4) established within the cover 12. Concurrently, the branching optical cable 7A extending from the optical connector 8A is housed within the fourth layer 29 (see FIG. 4) of the cover 12. Specifically, the branching optical cable 7A is guided through the gap between the clamps 34 and the side wall 32a to the end 12e of the cover 12. The branching optical cable 7A is then guided to the outside of the cover 12 along the X direction through the rubber seals 39 by the end 12e.

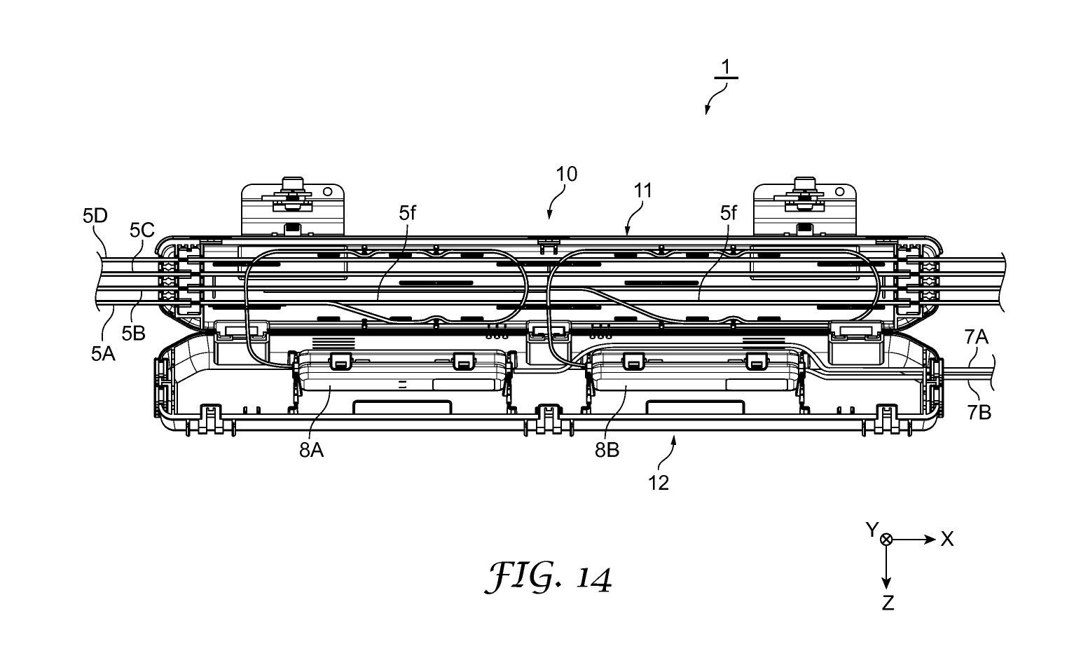

Through the steps 1 through 4 described above, the trunk optical cable 5A is split into the first optical cable 5f extending along the messenger wire 3 and the branching optical cable 7A extended into a residence or the like. Next, as shown in FIG. 14, the steps 1 through 4 described above are performed on the other trunk optical cables 5B to 5D, thereby likewise splitting the trunk optical cables 5B to 5D into first optical cables 5f and branching optical cables 7B to 7D. When the process of splitting the trunk optical cables 5B to 5D has been completed, the cover 12 is closed, and the work is complete.

In the present embodiment, the hanger 50 may be attached to the base 11 in advance, or attached to the base 11 after the base 11 and the cover 12 have been closed. In the present embodiment, all of the trunk optical cables 5A to 5D were operated upon, but it is also acceptable to operate upon as few as one of the cables as necessary. In the present embodiment, an example in which the trunk optical cable 5B is split after the trunk optical cable 5A has been split is discussed, but the order in which the cables are split can be selected as desired.

As described above, the branching optical cables 7A to 7D guided from the closure body 10 can be removed from the retaining piece 38 near the end 12e of the cover 12 without changing the positioning (moving) of the optical connectors 8A to 8D, and can also be removed from the retaining piece 38 near the other end 12f.

As discussed above, the first layer 14, second layer 15, and third layer 28 of the optical cable connection closure 1 according to the present embodiment are layered in the Y direction. The first through third layers 14, 15, and 28 are arranged so as to overlap each other as seen from the Y direction. Such a configuration allows the dimensions of the closure body 10 in the Z direction to be reduced, and the closure body 10 to be made more compact (miniaturized). It is thereby possible to make the closure body 10 suspended from the messenger wire 3 inconspicuous, and to improve the esthetic appeal of the optical cable connection closure 1 suspended from the messenger wire 3.

As described above, the closure body 10 also has the fourth layer 29 for housing the branching optical cables 7A to 7D, the fourth layer 29 being contained within the third layer 28. This allows the branching optical cables 7A to 7D to be housed without increasing the dimensions of the cover 12 in the Y direction or the Z direction, and the closure body 10 to be made more compact.

As described above, the base 11 and the cover 12 are linked by the hinges 13 in a manner that allows opening and closing. Such a configuration allows for easy access to the first through fourth layers 14, 15, 28, and 29 by opening the cover 12 off of the base 11. This reduces the need to provide a tray or the like in which to arrange the trunk optical cables 5A to 5D and the like on the base 11 or the cover 12, and enables a more compact design for the closure body 10.

As described above, when suspending the closure body 10 from the messenger wire 3, the orientation of the hanger 50 with respect to the base 11 can be changed. As a result, either an effect of improving the esthetic appeal of the closure body 10 or an effect of ensuring a space S for housing the cables can be selectively obtained.

As described above, the closure body 10 is formed in a box shape such that the base 11 constituting the first shell and the cover 12 constituting the second shell abut each other in the Y direction. As a result, the first through fourth layers 14, 15, 28, and 29 are arranged within the closure body 10, in which a sealed box-shaped area has been delineated. It is thus possible to protect the trunk optical cables 5A to 5D, second optical cables 5s, optical connectors 8A to 8D, and branching optical cables 7A to 7D housed within the closure body 10 from inclement weather, sunlight, and the like.

### Second Embodiment

Next, an optical cable connection closure according to a second embodiment will be described. The description of the present embodiment will focus on those points differing from the first embodiment described above.

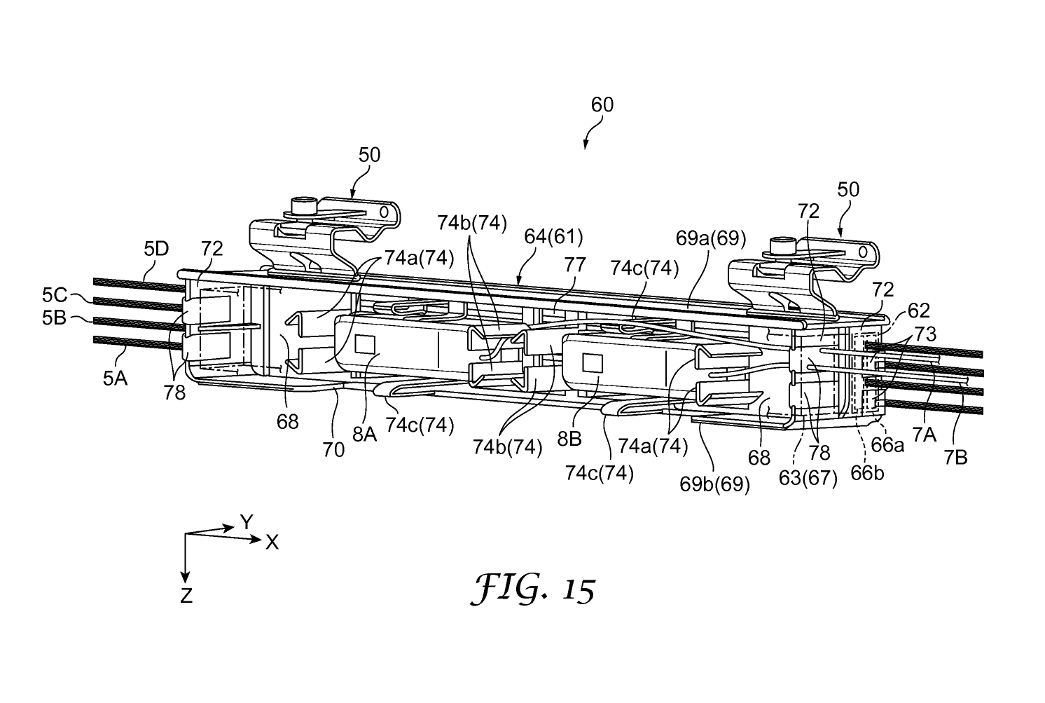

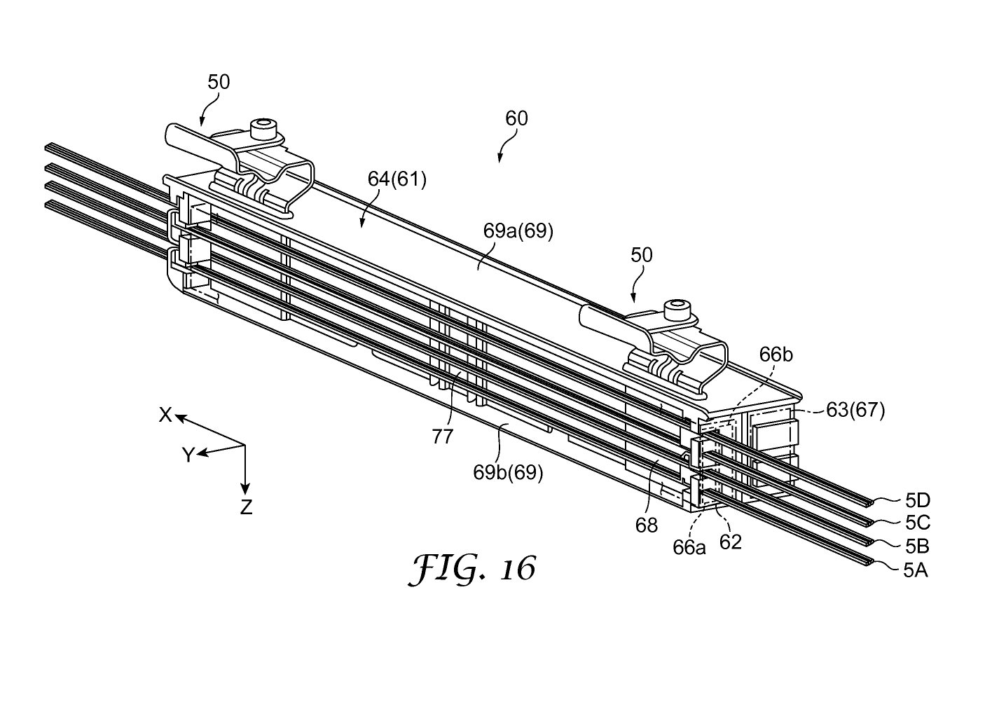

As shown in FIG. 15 and FIG. 16, an optical cable connection closure 60 according to the present embodiment differs from the optical cable connection closure 1 described above in that it is provided with a closure body 61 in lieu of the closure body 10 (see FIG. 1). The closure body 61 contains a frame 64.

The frame 64 constitutes the closure body 61. The frame 64 extends in the X direction, and delineates a first housing section 62 and a second housing section 63 lined up in the Y direction. First and second layers 66a and 66b are provided within the first housing section 62, and a third layer 67 is provided within the second housing section 63.

Specifically, the frame 64 contains a plate-shaped rib 68 perpendicular to the Y direction, a pair of flanges 69 provided on both ends of the rib 68 in the Z direction, and a plate-shaped side plate 72 perpendicular to the X direction. The frame 64 is made, for example, of plastic, and is rigid enough to support the trunk optical cables 5A to 5D, branching optical cables 7A to 7D, and optical connectors 8A to 8D.

A flange 69a on one side in the Z direction (the upper side in the drawing) has a planar shape. The base 53 of the hanger 50 (see FIG. 7) is secured to the flange 69a. A flange 69b on the other side in the Z direction (the lower side in the drawing) has a planar shape with a partial cutout therein. Specifically, as shown in FIG. 15, the flange 69b on one side of the rib 68 in the Y direction (the front side in the drawing) is only provided at both ends in the X direction, with an opening 70 being formed therebetween. The side plate 72 is provided on both ends of the rib 68 in the X direction so as to bridge the area between the pair of flanges 69.

In such a frame 64, as shown in FIG. 15 and FIG. 16, two areas that are long with respect to the X direction are separated by the rib 68, the flanges 69, and the side plate 72, one of the areas on one side in the Y direction constituting the second housing section 63, and the area on the other side in the Y direction constituting the first housing section 62. A plurality of slits 77 extending in the X direction through which the optical cables 5s are inserted is formed at the parts of the rib 68 corresponding to the opening 70. These slits 77 allow for the second optical cables 5s to pass between the second and third layers 66b and 67 (that is, between the first and second housing sections 62 and 63).

A first layer 66a is an area established in the first housing section 62 and has the X direction as its lengthwise direction. The first layer 66a houses the trunk optical cables 5A to 5D. The first layer 66a contains a rubber mount 73 positioned in a groove provided in the side plate 72. The rubber mount 73 houses the trunk optical cables 5A to 5D. The frame 64 of the closure body 61 thereby serves on its own to house the trunk optical cables 5A to 5D without the need for a part separate from the frame 64.

A second layer 66b is an area established further inside than the first layer 66a (that is, towards the rib 68) within the first housing section 62, and has the X direction as its lengthwise direction. In other words, the second layer 66b is layered in the Y direction so as to occupy the same position as the first layer 66a with respect to the Z direction. The second layer 66b houses the split second optical cables 5s.

The third layer 67 is an area established inside the second housing section 63, and has the X direction as its lengthwise direction. In other words, the third layer 67 is layered in the Y direction so as to occupy the same direction as the first and second layers 66a and 66b with respect to the Z direction. The third layer 67 houses the optical connectors 8A to 8D. FIG. 15 shows the optical connectors 8A and 8B in a housed state.

The third layer 67 contains a plurality of clamps 74 for housing the optical connectors 8A to 8D. The clamps 74 are vertical pieces rising off of the rib 68, and clamp and secure the optical connectors 8A to 8D in the X direction and the Y direction. The frame 64 of the closure body 61 thereby serves on its own to house the optical connectors 8A to 8D without the need for a part separate from the frame 64.

A fourth layer 76 is provided within the third layer 67, and contains a rubber mount 78 positioned within a groove provided on the side plate 72. The rubber mount 78 retains the branching optical cables 7A to 7D. The frame 64 of the closure body 61 thereby serves on its own to house the branching optical cables 7A to 7D without the need for a part separate from the frame 64.

As described above, the optical cable connection closure 60 according to the present embodiment also allows the dimension of the closure body 61 in the Z direction to be reduced, and the closure body 61 to be made more compact. It is thereby possible to make the closure body 61 suspended from the messenger wire 3 inconspicuous, and to improve the esthetic appeal of the optical cable connection closure 60 suspended from the messenger wire 3.

As described above, the first housing section 62 and the second housing section 63 sandwich the frame 64 in the Y direction, and are configured so as to be exposed to the exterior. It is thereby possible to arrange the trunk optical cables 5A to 5D from a predetermined orientation along the Y direction with respect to the first layer 66a provided in the first housing section 63. It is also possible to arrange the optical connectors 8A to 8D from a direction opposite that of the orientation used when arranging the trunk optical cables 5A to 5D with respect to the third layer 67 provided in the second housing section 63. Good ease of work is thereby ensured.

Preferred embodiments of the present invention have been described above, but the present invention is not limited to the embodiments described above, and various modifications and other applications are possible within the scope of the claims.

For example, in the first embodiment, the fourth layer 29 is included in the third layer 28, but it may instead be included in the second layer 15. In the first embodiment, the entirety of the first through third layers 14, 15, and 28 overlap in the Y direction, but it is also acceptable for parts thereof to overlap. This also yields the abovementioned effect of improving the esthetic appeal of the optical cable connection closure 1.

The closure body 61 housing the trunk optical cables 5A to 5D in the second embodiment described above may be covered by a protective cover not shown in the drawings. Various optical cables may be applied as the trunk optical cables 5A to 5D and the branching optical cables 7A to 7D.

The present invention may also be considered to be a method of splitting an optical cable (or an optical cable connection method) for housing a trunk optical cable and optically connecting a branching optical cable to a second optical cable via an optical connector.

What is claimed is:

1. An optical cable connection closure, having at least mutually separable first and second optical cables and housing a trunk optical cable extending in a predetermined direction, for optically connecting a branching optical cable to the second optical cable via an optical connector; wherein the closure is provided with a closure body that is suspended from a wire for supporting the trunk optical cable and that is rigid enough to support the trunk optical cable, the branching optical cable, and the optical connector; and the closure body has a first layer for housing the trunk optical cable, a second layer for housing the split-off second optical cable, and a third layer for housing the optical connector, the first through third layers being layered in that order in a suspension direction of the closure body and in a direction perpendicular to the predetermined direction, and at least parts thereof overlapping each other as seen from the perpendicular direction.

2. The optical cable connection closure according to claim 1, wherein the closure body further has a fourth layer for housing the branching optical cable, the fourth layer being comprised within either the second or the third layer.

3. The optical cable connection closure according to claim 1, wherein the closure body is formed in a box shape such that first and second shells abut each other in the perpendicular direction, the first layer being provided within the first shell, and the third layer being provided within the second shell.

4. The optical cable connection closure according to claim 1, wherein the closure body is formed comprising a frame extending in the predetermined direction so as to delineate first and second housing sections along the perpendicular direction, the first layer being provided within the first housing section, and the third layer being provided within the second housing section.

5. The optical cable connection closure according to claim 1, wherein a plurality of catches for retaining the second optical cable in a state wrapped in a circumferential direction around an axis extending in the perpendicular direction is provided within the second layer, part of the plurality of catches holding the second optical cable in place so as to be movable in the circumferential direction.
